(19) United States
(12) Patent Application Publication
(10) Pub. No.: US 2026/0277479 A1
(43) Pub. Date: Sep. 17, 2026

(54) SOLID-STATE STORAGE DEVICE AND METHOD OF DYNAMIC QUALITY-OF-SERVICE MANAGEMENT THEREOF

(71) Applicant: KIOXIA CORPORATION, Tokyo (JP)

(72) Inventor: Cheng Chan HE, Hsinchu (TW)

(73) Assignee: KIOXIA CORPORATION, Tokyo (JP)

(21) Appl. No.: 19/318,767

(22) Filed: Sep. 4, 2025

(30) Foreign Application Priority Data
Mar. 11, 2025 (CN) 202510281604.6
Mar. 11, 2025 (TW) 114108971

(51) Int. Cl. G06F 3/06

(52) U.S. Cl. CPC G06F 3/0659; G06F 3/0611; G06F 3/0679

(57) ABSTRACT

A solid-state storage device is provided, which includes a controller, a non-volatile memory, and a volatile memory. The non-volatile memory stores write data provided by a host. The volatile memory includes a submission queue and a wait queue. The controller fetches a plurality of access commands from the host, and record the access commands in the submission queue. The access commands include write commands and read commands. In response to the controller fetching a first write command from the submission queue, the controller determines whether a read count value of the read commands and a standby time from receiving the first write command meet a target condition. If so, the controller executes the first write command. Otherwise, the controller retains the first write command in the wait queue.

### CROSS-REFERENCE TO RELATED APPLICATIONS

The present application is based on, and claims priority from, Taiwan Application Serial Number 114108971, filed on Mar. 11, 2025, and China Application Serial Number 202510281604.6, filed on Mar. 11, 2025, the entirety of which are hereby incorporated by reference herein.

### TECHNICAL FIELD

The present invention relates to solid-state storage devices, and, in particular, a solid-state storage device and a method of dynamic quality-of-service (QoS) management thereof.

### BACKGROUND

Solid-state storage devices use non-volatile memory to store data, and are widely used in different computer systems with the development of technology. However, due to the characteristics of non-volatile memory, the number of data read and write operations performed thereon is closely related to the lifespan of the non-volatile memory. The ratio of read commands and write commands input to a solid-state storage device varies greatly, such that the storage device manages different system workloads. Traditional solid-state storage devices are often designed for specific system workloads, and when the system workload changes significantly, performance can be significantly affected, impacting quality-of-service (QoS) thereof.

### SUMMARY OF THE DISCLOSURE

Accordingly, a solid-state storage device and a method of dynamic QoS management thereof are provided to address the problems noted.

An aspect of the present invention provides a solid-state storage device, which includes a controller, a non-volatile memory, and a volatile memory. The solid-state storage device is electrically connected to a host. The non-volatile memory is electrically connected to the controller, and configured to store write data provided by the host. The volatile memory includes a submission queue and a wait queue. The controller is configured to fetch a plurality of access commands from the host, and record the access commands in the submission queue, the access commands comprising a plurality of write commands and a plurality of read commands. The access commands include write commands and read commands. In response to the controller fetching a first write command of the write commands from the submission queue, the controller is configured to determine whether a read count value of the read commands and a standby time from receiving the first write command meet a target condition. In response to the read count value and the standby time meeting the target condition, the controller is configured to execute the first write command. In response to the read count value and the standby time not meeting the target condition, the controller is configured to retain the first write command in the wait queue.

Another aspect of the present invention provides a dynamic QoS management method for a solid-state storage device. The solid-state storage device is electrically connected to a host, and includes a controller, a volatile memory, and a non-volatile memory. The method includes the following steps: utilizing the controller to fetch a plurality of access commands from the host, and recording the access commands in a submission queue of the volatile memory, wherein the access commands include a plurality of write commands and a plurality of read commands; in response to the controller fetching a first write command of the write commands from the submission queue, utilizing the controller to determine whether a read count value of the read commands and a standby time from receiving the first write command meet a target condition; in response to the read count value and the standby time meeting the target condition, utilizing the controller to execute the first write command; in response to the read count value and the standby time failing to meet the target condition, utilizing the controller to retain the first write command in a wait queue of the volatile memory.

### BRIEF DESCRIPTION OF THE DRAWINGS

Aspects of the present invention are best understood from the following detailed description when read with the accompanying figures. It is noted that in accordance with the standard practice in the industry, various features are not drawn to scale. In fact, the dimensions of the various features may be arbitrarily increased or reduced for clarity of discussion.

FIG. 1 is a block diagram of a computer system in accordance with an embodiment of the present invention.

FIG. 2 is a diagram of a programming procedure of a write command being interrupted by multiple read commands according to an embodiment of the present invention.

FIG. 3 is a flowchart of a dynamic QoS management method for a solid-state storage device according to an embodiment of the present invention.

FIG. 4 is a flowchart of firmware executed by the controller according to an embodiment of the present invention.

FIG. 5 is a flowchart of the command control module in the embodiment of FIG. 4.

FIG. 6 is a flowchart of the read credit control module in the embodiment of FIG. 4.

FIG. 7 is a flowchart of the command equalizer module in the embodiment of FIG. 4.

FIGS. 8A and 8B are diagrams illustrating adjustment of the reference value REF and the read credit under different situations by the controller according to an embodiment of the present invention.

### DETAILED DESCRIPTION

The following description is for the purpose for describing preferred embodiments of the present invention, with the aim of describing the basic spirit of the present invention, but not to limit the present invention. The actual content of the disclosure should be referred to the appended claims.

It should be understood that the words “comprising” and “including” used in this specification are used to indicate the existence of specific technical features, numerical values, method steps, work processes, elements and/or components, but not to exclude additional technical features, numerical values, method steps, operations, elements, components, or any combination thereof.

The use of words such as “first”, “second”, and “third” in the scope of the patent application are used to modify the elements in the scope of the patent application, and are not used to indicate the priority order or precedence relationship between them, one component precedes another component, or the time sequence in which method steps are executed, and is only used to distinguish components with the same name.

The term “configured to” may describe or claim that various units, circuits, or other components are “configured to” perform a task or tasks. In such contexts, the term “configured to” is used by indicating that the units/circuits/components include a structure (e.g., circuitry) that performs their task(s) during operation. Thus, a specified unit/circuit/component may be said to be configured to perform the task even when the unit/circuit/component is not currently operating (e.g., not turned on). Such units/circuits/components used with the term “configured to” include hardware—for example: circuits, memory (which stores program commands that are executable to perform operations), etc. Additionally, “configured to” may include a generic structure (e.g., general circuitry) that is manipulated by software and/or firmware (e.g., an FPGA or a general-purpose processor executing the software) to operate in a manner that enables the execution of the task(s) to be solved. The term “configured to” may also include adapting a manufacturing process (e.g., a semiconductor manufacturing equipment) to produce a device (e.g., an integrated circuit) adapted to implement or perform one or more tasks.

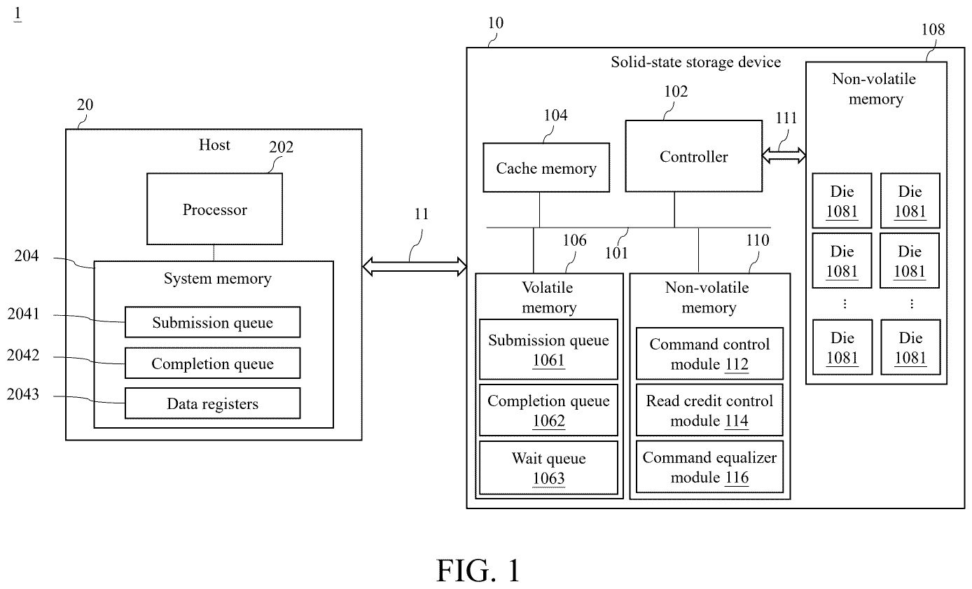

FIG. 1 is a block diagram of a computer system in accordance with an embodiment of the present invention.

As shown in FIG. 1, the computer system 1 may include a solid-state storage device 10 and a host 20. The solid-state storage device 10 may be electrically connected to the host 20 through bus 11 for command and data transmission. In some embodiments, bus 11 may be a Universal Serial Bus (USB), a Serial Advanced Technology Attachment (SATA) bus, or a Peripheral Component Interconnect Express (PCI Express, PCIe) bus, etc., but the disclosure is not limited thereto.

The solid-state storage device 10 may include a controller 102, a cache memory 104, a volatile memory 106, a non-volatile memory 108, and a non-volatile memory 110. The controller 102, volatile memory 106, non-volatile memory 108, and non-volatile memory 110 are electrically connected through internal bus 101. The controller 102 may be configured to control data access of the cache memory 104, the volatile memory 106, and the non-volatile memory 108. In some embodiments, the controller 102 may be, for example, a general-purpose processor, a microcontroller, an application-specific integrated circuit (ASIC), or a field programmable gate array (FPGA), etc., but the present invention is not limited thereto. Additionally, the controller 102 may be electrically connected to the non-volatile memory 108 through the data transmission interface 111, wherein the data transmission interface 111 may be, for example, an Open NAND Flash Interface (ONFI), a Toggle Mode Interface, an embedded MultiMediaCard (eMMC), a Universal Flash Storage (USF) interface, etc., but the present invention is not limited thereto.

The cache memory 104 may include, for example, a static random access memory (SRAM), but the present invention is not limited thereto. The volatile memory 106 may include, for example, a dynamic random access memory (DRAM), but the disclosure is not limited thereto. In some embodiments, the cache memory 104 and the volatile memory 106 may be disposed externally to the controller 102. In some other embodiments, the cache memory 104 and the volatile memory 106 may be integrated into the controller 102.

The non-volatile memory 110 may be, for example, a read-only memory (ROM), which is used to store the firmware module executed by the controller 102, such as a command control module 112, a read credit control module 114, and a command equalizer module 116, the functions of which will be detailed later.

The host 20 may include, for example, a processor 202 and a system memory 204, and the processor 202 is electrically connected to the system memory 204. In some embodiments, the processor 202 may include, for example, a central processing unit (CPU), a general-purpose processor, a microprocessor, and the like, but the present invention is not limited thereto. In addition, the processor 202 includes a controller (not shown) for controlling data access of the system memory 204. The system memory 204 may include, for example, dynamic random access memory (DRAM), but the present invention is not limited thereto.

In some embodiments, the host 20 may support the Non-Volatile Memory Express (NVMe) protocol, and the system memory 204 may be equipped with a submission queue 2041, a completion queue 2042, and data registers 2043. The submission queue 2041 may be configured to record access commands issued by the processor 202, and the completion queue 2042 may be configured to record the status of the completed access commands from the solid-state storage device 10. The data registers 2043 may be configured to store data to be written to the solid-state storage device 10 by the host 20 and data read from the solid-state storage device 10 by the host 20.

In some embodiments, the solid-state storage device 10 may support the Non-Volatile Memory Express (NVMe) protocol, and the controller 102 can fetch access commands, such as write commands and read commands, from the submission queue 2041 of the host 20. The volatile memory 106 may be equipped with a submission queue 1061, a completion queue 1062, and a wait queue 1063. The submission queue 1061 is configured to record access commands fetched from the host 20. The completion queue 1062 is configured to record the status of completed access commands of the solid-state storage device 10. The wait queue 1063 is configured to record one or more access commands pushed from the submission queue 1061.

The non-volatile memory 108 may be a flash memory, such as a NAND flash memory. Alternatively, the non-volatile memory 108 may be next-generation memory product types, such as ferroelectric random access memory (FeRAM), phase-change memory (PCM), magnetoresistive random access memory (MRAM), and resistive random access memory (ReRAM). The non-volatile memory 108 is configured to store write data provided by the host 20, wherein the non-volatile memory 108 may be composed of a plurality of dies 1081. In some embodiments, the non-volatile memory 108 may include multiple channels, and each channel may include one or more dies 1081. In addition, each channel is equipped with corresponding submission queues 1061, completion queues 1062, and wait queues 1063. Additionally, the controller 102 may distribute access commands from the host 20 to the corresponding submission queues 1061, completion queues 1062, and wait queues 1063 of each channel. In some embodiments, the wait queues 1063 corresponding to each channel may form a command schedule layer (not shown in FIG. 1). The non-volatile memory 108 may include a plurality of blocks, and each block includes a plurality of pages. In some embodiments, for the purposes of description, each die 1081 of the non-volatile memory 108 includes 1024 blocks, and each block includes 64 pages. Assuming that the capacity of each page is 16K bytes, the capacity of each block is 1M bytes. The aforementioned disclosure is for illustrative purposes only, and the manufacturer of the non-volatile memory 108 can determine the number of pages in each block and the capacity of each page.

In some embodiments, when the host 20 intends to store write data into the solid-state storage device 10, the processor 202 stores the write data corresponding to a write command into the data registers 2043 of the system memory 204, and writes the write command into the submission queue 2041. For example, the content of the write command includes the logical address of the write data, such as 0x2000, and the size of the write data, such as 16K bytes.

In some embodiments, the controller 102 of the solid-state storage device 10 may periodically check whether there is a new access command in the submission queue 2041. The controller 102 of the solid-state storage device 10 may fetch the write command from the submission queue 2041 and record the fetched write command in the submission queue 1061 of the volatile memory 106.

It should be noted that, for the solid-state storage device 10, compared with read commands, write commands from the host 20 may have a longer response time. Therefore, in an embodiment of the present invention, after the controller 102 fetches the write command from the submission queue 2041, the controller 102 may execute the write command to program one of the dies 1081 in the non-volatile memory 108. At this time, the write command is in a pending status and remains recorded in the submission queue 1061, while the write data corresponding to the write command remains stored in the data registers 2043 of the host 20.

When the controller 102 fetches a read command from the submission queue 2041 of the host 20 during the programming period of the write command, the controller 102 will determine whether a target condition is satisfied to determine whether to execute the write command first or interrupt the write command to execute the read command. When the controller 102 determines that the target condition is satisfied, the controller 102 will execute the write command with priority, and after the programming procedure of the write command is completed (i.e., the controller 102 transfers the write data from the data registers 2043 of the host 20 to the volatile memory 106, and programs the write data into the non-volatile memory 108), the controller 102 transmits first command completion information corresponding to the write command to the completion queue 1062, and writes the first command completion information stored in the completion queue 1062 into the completion queue 2042 of the host 20. Specifically, the controller 102 writes the first command completion information corresponding to the write command into the completion queue 1062, and deletes the write command from the submission queue 1061. The controller 102 then writes the first command completion information corresponding to the write command into the completion queue 2042 of the host 20, and deletes the entry corresponding to the write command in the submission queue 2041 of the host 20.

In some embodiments, the controller 102 may set the phase tag, which corresponds to the first command completion information of the write command, in the completion queue 2042 to 1, and issue an interrupt signal to the processor 202 to notify the processor 202 that new command completion information has been submitted to the completion queue 2042. When the processor 202 receives the interrupt signal, the processor 202 may use the set phase tag to check the new entry in the completion queue 2042. When the new entry reports that the command has been executed successfully, the processor 202 will close the related event of the write command and record that the write data of the write command has been successfully written into the solid-state storage device 10.

When the controller 102 determines that the target condition is not satisfied, the controller 102 interrupts the write command to execute the read command, and after the read command is completed (i.e., the read data corresponding to the read command is successfully written into the data registers 2043 of the host 20), the controller 102 transmits the second command completion information corresponding to the read command to the completion queue 1062, and writes the second command completion information stored in the completion queue 1062 into the completion queue 2042 of the host 20. Therefore, the processor 202 of the host 20 may know that the read command has been successfully executed via the second command completion information corresponding to the read command in the completion queue 2042. When the read command has been successfully executed, the controller 102 resumes the programming procedure of the write command and executes the programming procedure until the write command is completed.

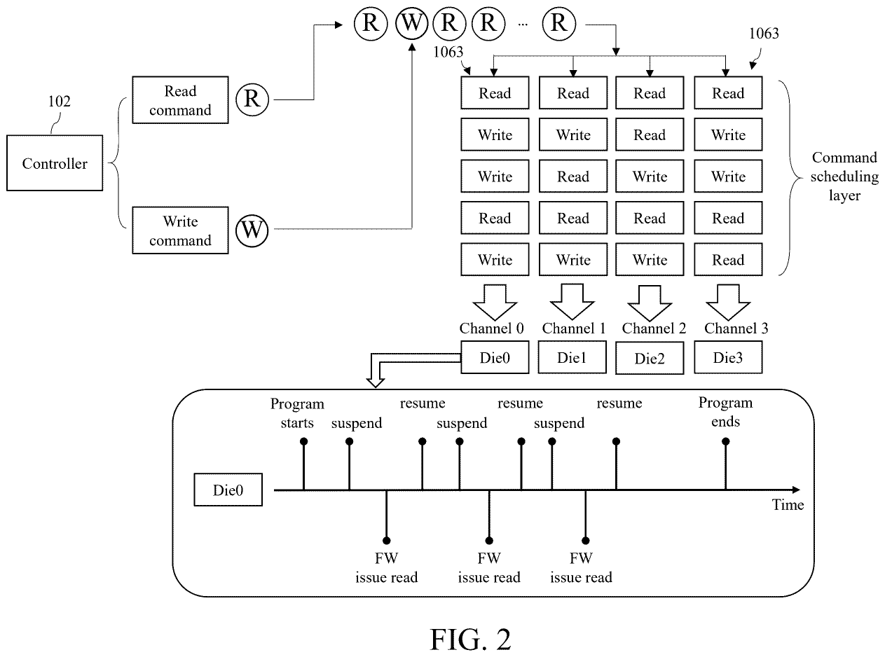

FIG. 2 is a diagram of a programming procedure of a write command being interrupted by multiple read commands according to an embodiment of the present invention.

In some embodiments, the controller 102 may function as a command sensor, such as fetching access commands, including read commands and write commands, from the submission queue 2041 of the host 20. For the purposes of description, the non-volatile memory 108 has four channels, such as channels 0 to 3, which correspond to dies 0 to 3, respectively. In addition, the controller 102 may write each read command and write command fetched from the submission queue 2041 into the wait queue 1063 of the corresponding channel. The wait queues 1063 of each channel may be collectively referred to as a command schedule layer, as shown in FIG. 2.

For simplicity, the embodiment of FIG. 2 is described using the programming procedure of one write command of die 0 as an example. After the programming procedure of the write command starts, when the controller 102 receives a first read command of channel 0, the controller 102 suspends the programming procedure. After the first read command is completed, the controller 102 resumes the programming procedure. However, when the controller 102 receives a second read command of channel 0, the controller 102 also suspends the programming procedure. After the second read command is completed, the controller 102 resumes the programming procedure. The controller 102 may repeatedly perform the aforementioned process of receiving read commands and suspending the programming procedure of the write command. When the number of read commands received by the controller 102 during the programming procedure of the write command is too high, it will affect the response time of the controller 102 to the host 20, for example, exceeding 200 μs, thereby affecting QoS.

Specifically, the computer system 1 may be designed to handle application scenarios of “write queue depth (Write QD)=1, and write data throughput=80 MiB/s” and “read queue depth (Read QD)=8, and read data throughput=600 MiB/s.” The write queue depth indicates the maximum number of write commands that can be stored in the wait queue 1063, and the read queue depth indicates the maximum number of read commands that can be stored in the wait queue 1063. However, in some special application scenarios, the solid-state storage device 10 may execute more write commands than the expected application scenario, resulting in reversed throughputs for write commands and read commands. In addition, the aforementioned situation will also increase read latency due to the large amount of data from write operations, thereby affecting the performance of read operations. The controller and dynamic QoS management method proposed by the present invention can effectively control and solve QoS requirements, for example, by providing appropriate bandwidth based on the write queue depth, read queue depth, and the data size of command requests to address the problem of QoS latency. For example, the controller 102 in the present invention may adjust the settings of the command sensor to limit resources for write commands, thereby reducing the impact of write commands on resources for read commands.

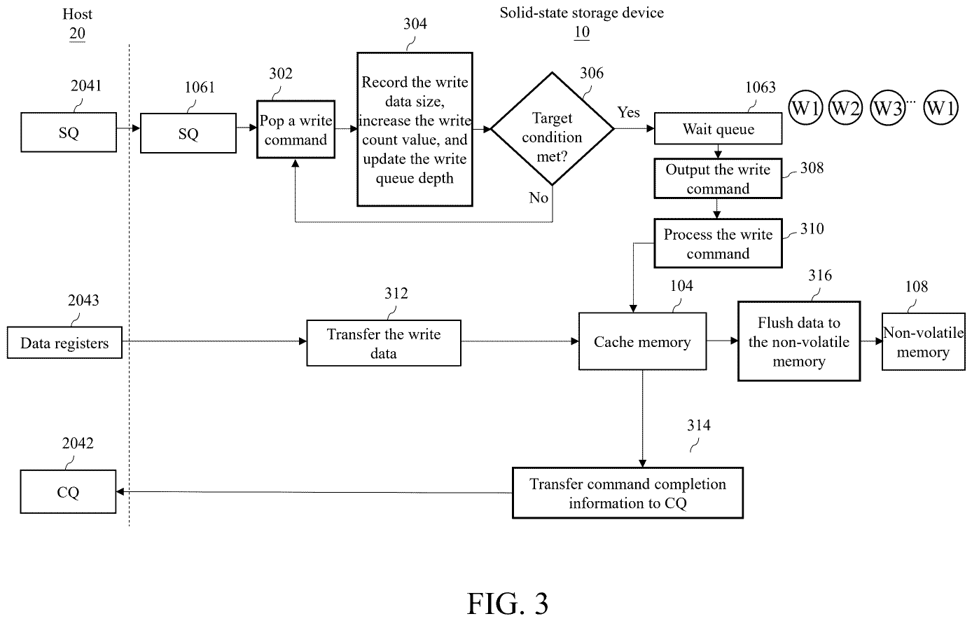

FIG. 3 is a flowchart of a dynamic QoS management method for a solid-state storage device according to an embodiment of the present invention. Please refer to both FIGS. 1 and 3.

In step 302, when the command sensor executed by the controller 102 is activated, the controller 102 may control the submission queue 2041 (or the submission queue 1061) to push a write command. In some embodiments, the aforementioned operation is equivalent to the controller 102 fetching a write command from the submission queue 2041, and the controller 102 storing the fetched write command into the submission queue 1061. In addition, for purposes of description, the write commands may be classified into write commands W1, W2, and W3 with write data sizes of 4K, 8K, and 16K bytes, respectively. In some embodiments, when the solid-state storage device 10 operates in practice, the write data size of the write commands and the read data size of the read commands generally range from 4K to 256K bytes, with the maximum value determined by a parameter value of the maximum data transfer size of the solid-state storage device 10.

In step 304, the controller 102 records the write data size, increases the write count value (e.g., by adding 1), and updates the write queue depth. In some embodiments, the controller 102 may include related registers (not shown) to record the write data size, write count value, and write queue depth. In addition, the write count value and the write queue depth may be used by the read credit control module 114 and the command equalizer module 116 to perform related determinations.

In step 306, the controller 102 determines whether the read count value and the standby time meet the target condition. When the controller 102 determines that the read count value and the standby time meet the target condition, the controller 102 controls the wait queue 1063 to pop the write command (step 308) and processes the write command (step 310). Processing the write command in step 310 may include searching a logical-to-physical mapping table in the cache memory 104 and/or the non-volatile memory 108, and allocating data storage space in the cache memory 104 or the volatile memory 106 to store the write data of the data registers 2043 of the host 20, such as when the controller 102 executes step 312 to transfer the write data from the data registers 2043 to the cache memory 104 (or the volatile memory 106). When the controller 102 determines that the read count value and the standby time do not meet the target condition, the flow returns to step 302, and the controller 102 may control the submission queue 2041 (or the submission queue 1061) to push the write command.

In step 314, in response to the write data being successfully transferred to the cache memory 104 (or the volatile memory 106), the controller 102 transmits the command completion information corresponding to the write command to the completion queue 2042. In some embodiments, after the controller 102 transmits the command completion information corresponding to the write command to the completion queue 2042, it indicates that the write command has been successfully executed. The controller 102 further decreases the write count value (e.g., by subtracting 1), meaning that the number of write commands in the wait queue 1063 decreases by 1.

In step 316, when the size of one or more pieces of the write data stored in the cache memory 104 (or the volatile memory 106) reaches the size of one word line (e.g., a page of 16K bytes), the controller 102 clears the write data stored in the cache memory 104 (or the volatile memory 106) into the non-volatile memory 108, for example, programming the page-sized write data into a spare block or a spare page of a partially filled data block in the non-volatile memory 108.

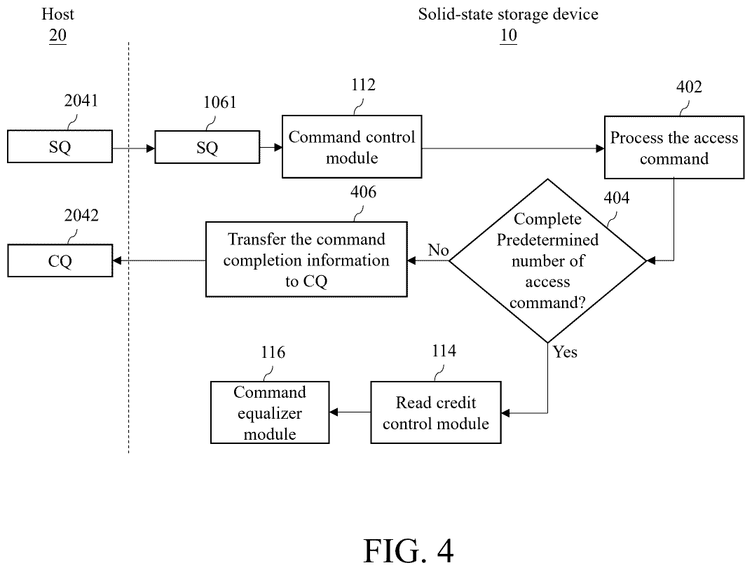

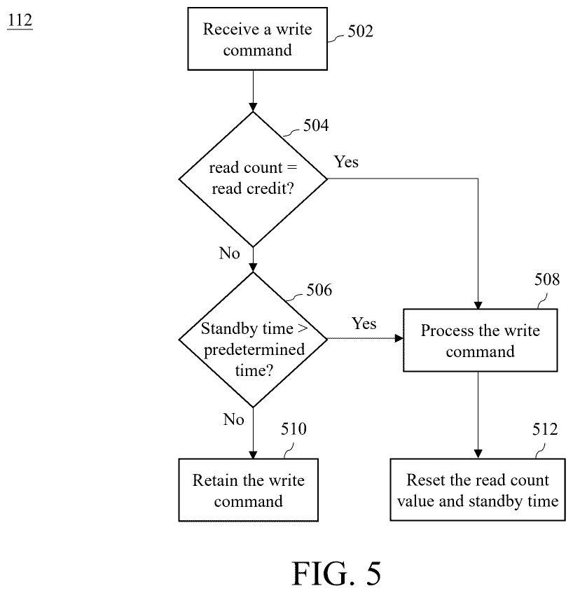

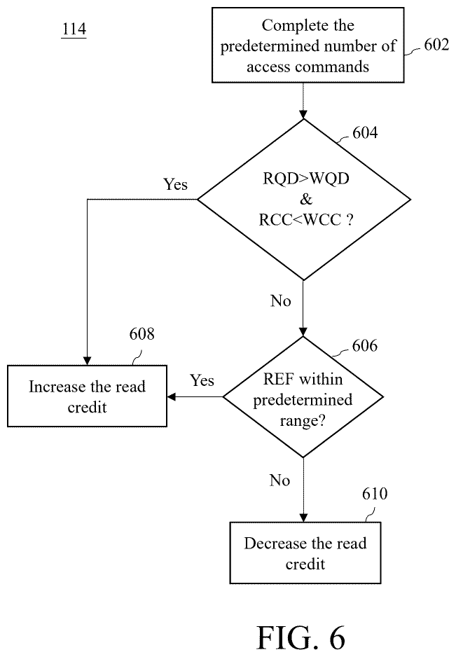

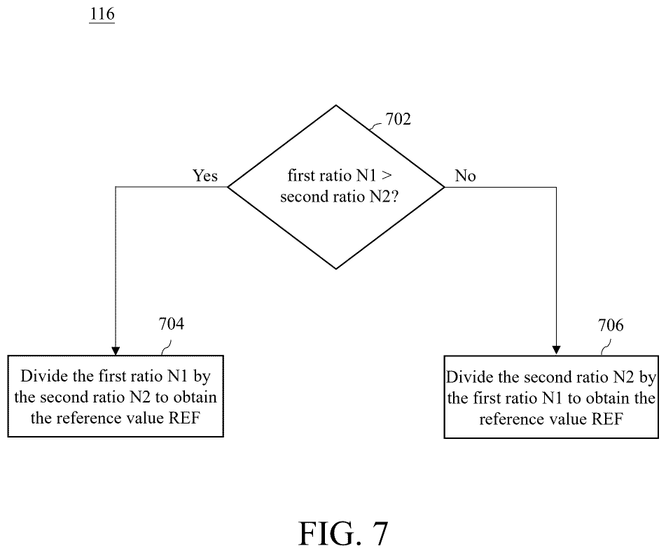

FIG. 4 is a flowchart of firmware executed by the controller according to an embodiment of the present invention. FIG. 5 is a flowchart of the command control module in the embodiment of FIG. 4. FIG. 6 is a flowchart of the read credit control module in the embodiment of FIG. 4. FIG. 7 is a flowchart of the command equalizer module in the embodiment of FIG. 4. Please refer to all of FIG. 1 and FIGS. 3 to 7.

In some embodiments, the controller 102 writes the write commands or read commands fetched from the submission queue 2041 of the host 20 into the submission queue 1061 in the solid-state storage device 10. The firmware modules executed by the controller 102 mainly include a command control module 112, a read credit control module 114, and a command equalizer module 116, as shown in FIG. 4. In addition, the command control module 112, the read credit control module 114, and the command equalizer module 116 operate together.

Please refer to FIG. 5. In some embodiments, the command control module 112 is configured to determine whether a read command meets specific multiple conditions, for example, the determination steps in steps 504 and 506. The command control module 112 may include a command decoder. Each time the controller 102 fetches an incoming access command from the submission queue 2041 of the host 20 into the submission queue 1061 of the solid-state storage device 10, the command decoder executed by the controller 102 determines whether the incoming access command is a read command or a write command. When the incoming access command received by the controller 102 is a write command (step 502), the controller 102 records the data size of the write command, increases the write count value, increases the write queue depth by 1, and places the write command into the wait queue 1063. Next, the controller 102 determines whether the read count value equals the read credit (step 504). For example, if the read credit=20, the controller 102 executes 1 write command after completing 20 read commands, and so on. In addition, the read credit can be regarded as the ratio of the number of read commands executed by the controller 102 to the number of write commands executed. The read count value indicates the number of read commands that the controller 102 has executed within the read credit.

When the controller 102 determines that the read count value equals the read credit, the controller 102 processes the write command (step 508). When the controller 102 completes the write command, the controller 102 increases the write completed count value, resets the read count value and the standby time (step 512), decreases the write queue depth by 1, and writes the command completion information, which corresponds to the write command, into the completion queue 1062. The controller 102 then writes the command completion information, which corresponds to the write command stored in the completion queue 1062, into the completion queue 2042 of the host 20 to notify the processor 202 that the write command has been completed. For example, the controller 102 may calculate the standby time between receiving the write command and receiving a next read command. If the standby time exceeds a predetermined time, it indicates that the controller 102 has not received any read command within the predetermined time, and the controller 102 will directly execute the write command. Therefore, the aforementioned standby time determination mechanism can prevent a write command from timing out. In some embodiments, the predetermined time is approximately 50 μs, but the present invention is not limited thereto.

When the controller 102 determines that the read count value does not equal the read credit (i.e., the read count value has not yet reached the read credit), the controller 102 further determines whether the standby time of the write command exceeds the predetermined time (step 506). When the controller 102 determines that the standby time of the write command exceeds the predetermined time, the controller 102 processes the write command (step 508). When the controller 102 completes the write command, the controller 102 increases the write completed count value, resets the read count value and the standby time (step 512), decreases the write queue depth by 1, and writes the command completion information, which corresponds to the write command, into the completion queue 1062. The controller 102 then writes the command completion information, which corresponds to the write command stored in the completion queue 1062, into the completion queue 2042 of the host 20 to notify the processor 202 that the write command has been completed. When the controller 102 determines that the standby time of the write command does not exceed the predetermined time, the controller 102 does not process the write command but retains the write command (step 510), for example, keeping the write command in the wait queue 1063. At this time, the controller 102 processes incoming read commands first, until the read count value reaches the read credit or the standby time of the write command exceeds the predetermined time, and then fetches the write command from the wait queue 1063 for execution.

In some embodiments, when the incoming access command received by the controller 102 is a read command, the controller 102 records the data size of the read command, increases the read count value, increases the read queue depth by 1, and then places the read command into the wait queue 1063. Next, the controller 102 may fetch the read command from the wait queue 1063 for execution. When the controller 102 completes the read command, the controller 102 increases the read completed count value, decreases the read queue depth by 1, and writes the command completion information of the read command into the completion queue 1062. The controller 102 then writes the command completion information, which corresponds to the read command stored in the completion queue 1062, into the completion queue 2042 of the host 20 to notify the processor 202 that the read command has been completed.

Please refer to FIG. 6. In some embodiments, the read credit control module 114 is configured to determine whether the solid-state storage device 10 complies with a specified command queue depth, so as to determine whether the read credit needs to be adjusted. In some embodiments, each time the controller 102 completes a predetermined number of access commands (step 602), the controller 102 determines whether the predetermined condition is satisfied, for example, “the read queue depth (RQD) is greater than the write queue depth (WQD), and the read completed count (RCC) is less than the write completed count (WCC)” (step 604). In some embodiments, the predetermined number is 200, but the present invention is not limited thereto. The predetermined number may be adjusted according to practical situations. In addition, the aforementioned access commands include read commands and write commands, and the predetermined number is the sum of the read completed count and the write completed count. In some embodiments, the read completed count and the write completed count may be represented by the number of read input/output operations and the number of write input/output operations, respectively.

When the controller 102 determines that the predetermined condition is satisfied, the controller 102 increases the read credit (step 608). When the controller 102 determines that the predetermined condition is not satisfied, the controller 102 further determines whether a reference value REF is within a predetermined range (step 606), wherein the predetermined range of the reference value REF may be, for example, between 0 and 2. When the controller 102 determines that the reference value REF is within the predetermined range, the controller 102 increases the read credit (step 608). When the controller 102 determines that the reference value REF is not within the predetermined range, the controller 102 decreases the read credit (step 610). In some embodiments, the controller 102 may use the reference value REF to determine whether the solid-state storage device 10 matches a predetermined workload pattern or a current workload pattern.

It should be noted that each time the controller 102 completes a predetermined number of access commands, the increased or decreased read credit is used in the next cycle of the predetermined number of access commands. For example, in step 504 of FIG. 5, the updated read credit will be used for determination. In other words, the controller 102 may periodically (e.g., every time the predetermined number of access commands is completed, such as 200 commands) adjust the dynamic value (e.g., the read credit) according to the workload of the computer system 1. In addition, the reference value REF may represent a ratio between a first ratio N1 and a second ratio N2 (e.g., REF=N1/N2 or N2/N1) each time the controller 102 has executed the predetermined number of access commands, where the first ratio N1 denotes “the read completed count (RCC) to the write completed count (WCC)” (e.g., first ratio N1=RCC/WCC), and the second ratio N2 denotes “the read command weighted score (RCWS) to the write command weighted score (WCWS)” (e.g., second ratio N2=RCWS/WCWS). Further details are described as follows.

Please refer to FIG. 7. In some embodiments, the command equalizer module 116 is configured to calculate the reference value REF, serving as an equalizer for controlling the read data throughput and the write data throughput. For example, the controller 102 determines whether a specific condition is satisfied, such as whether the first ratio N1 is greater than the second ratio N2 (step 702). When the controller 102 determines that the specific condition is satisfied, the controller 102 divides the first ratio N1 by the second ratio N2 to obtain the reference value REF, i.e., REF=N1/N2 (step 704). When the controller 102 determines that the specific condition is not satisfied, the controller 102 divides the second ratio N2 by the first ratio N1 to obtain the reference value REF, i.e., REF=N2/N1 (step 706).

Specifically, when the controller 102 determines that the specific condition is satisfied, it indicates that the resources of the solid-state storage device 10 used for read commands need to be managed or adjusted. If the controller 102 uses all the resources of the solid-state storage device 10 to execute read commands, the resources for write commands will become extremely unbalanced and cannot meet the requirements of the expected workload.

In some embodiments, the firmware executed by the controller 102 may assign individual read/write weights to read commands and write commands with different read/write data sizes, so as to reflect the impact of each read command and write command on the read queue and the write queue, respectively. For purposes of description, the range of write data sizes and read data sizes is between 4K bytes and 256K bytes, as shown in Table 1.

TABLE 1

| Write data size | Write | Read data size | Read |
|---|---|---|---|
| (bytes) | weight | (bytes) | weight |
| 4K | 2 | 4K to 32K | 1 |
| 8K to 16K | 1 | 33K to 64K | 2 |
| 16K to 256K | 4 | 65K to 256K | 3 |

It should be noted that the write weights and read weights shown in Table 1 are for illustrative purposes only, and their initial values may be adjusted according to practical conditions. For example, the initial values of the write weights and read weights may be stored in the firmware of the controller 102.

In another embodiment, for simplicity and brevity, a cycle of 200 access commands is used, wherein the write weights and write completed count values of write commands are shown in Table 2, and the read weights and read completed count values of read commands are shown in Table 3.

TABLE 2

| Write data size | | | | Write command |
|---|---|---|---|---|
| (bytes) | 4K | 8K | 16K | weighted score |
| Write weight | 12 | 5 | 5 | 17 |
| Write completed | 1 | 0 | 1 | |
| count value | | | | |

TABLE 3

| Read data size | | | | Read command |
|---|---|---|---|---|
| (bytes) | 4K | 8K | 16K | weighted score |
| Read weight | 4 | 6 | 8 | 34 |
| Read completed | 2 | 3 | 1 | |
| count value | | | | |

For example, for write commands with write data sizes of 4K, 8K, and 16K bytes, their write weights are 12, 5, and 5, respectively, and their write count values are 1, 0, and 1, respectively. For read commands with read data sizes of 4K, 8K, and 16K bytes, their read weights are 4, 6, and 8, respectively, and their read count values are 2, 3, and 1, respectively. Therefore, the controller 102 can calculate the write command weighted score=12*1+5*0+5*1=17, and calculate the read command weighted score=4*2+6*3+8*1=34. Accordingly, the controller 102 can calculate the second ratio N2=34/17=2. For purposes of description, this cycle of 200 access commands includes 160 read commands and 40 write commands, indicating that the read count value is 160 and the write count value is 40. In addition, the controller 102 can calculate the first ratio N1=160/40=4.

In this embodiment, since the specific condition is satisfied, i.e., the first ratio N1>the second ratio N2, the controller 102 divides the first ratio N1 by the second ratio N2 to obtain the reference value REF, i.e., REF=N1/N2=4/2=2. It should be noted that if the specific condition is not satisfied, the controller 102 divides the second ratio N2 by the first ratio N1 to obtain the reference value REF, i.e., REF=N2/N1.

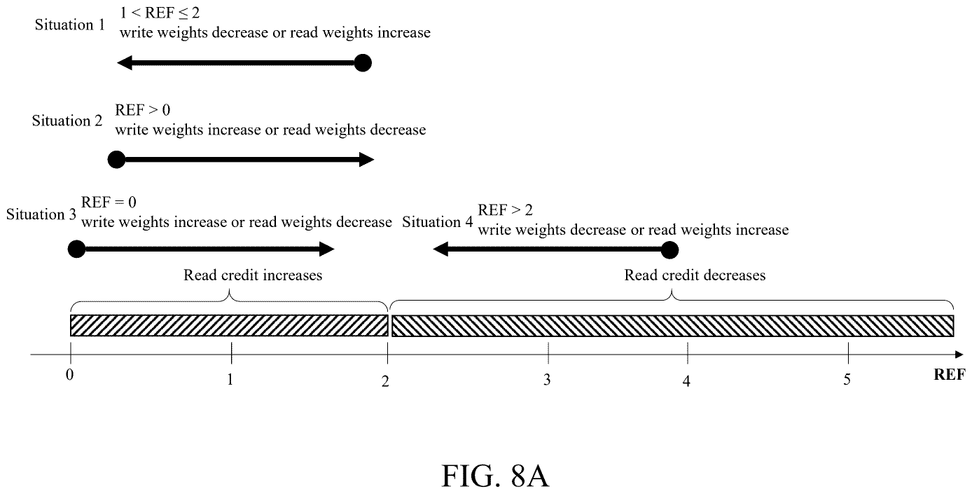

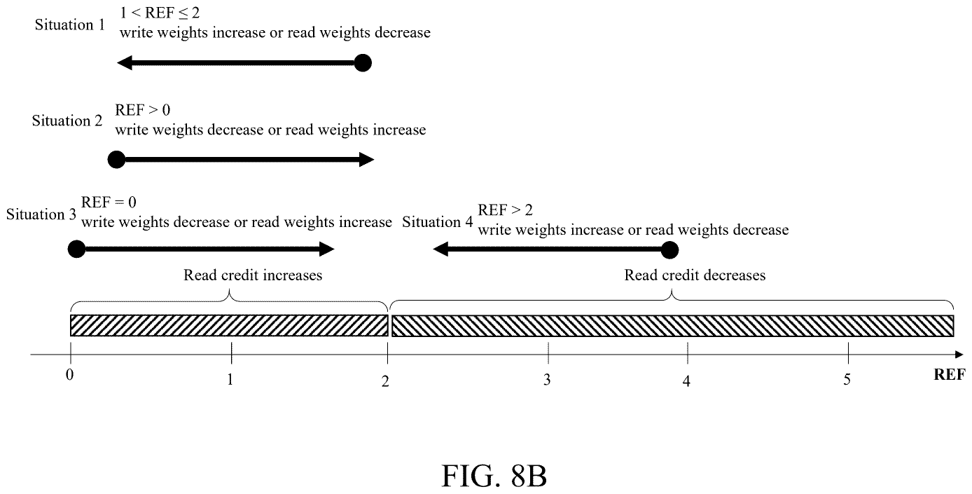

FIGS. 8A and 8B are diagrams illustrating adjustment of the reference value REF and the read credit under different situations by the controller according to an embodiment of the present invention.

In some embodiments, for purposes of description, assuming that the first ratio N1 is greater than the second ratio N2, and the first ratio N1 is a fixed value, the controller 102 may consider four different situations according to the numerical range of the reference value REF, as shown in situations 1 to 4 in FIG. 8A. When the write weight increases or the read weight decreases, the reference value REF decreases (or moves left). When the write weight decreases or the read weight increases, the reference value REF increases (or moves right). In brief, the controller 102 repeatedly attempts to align the first ratio N1 and the second ratio N2, i.e., adjust toward REF=1, thereby allowing the solid-state storage device 10 to allocate read data throughput and write data throughput according to the expected workload ratio.

Please refer to FIG. 8A. In situation 1, the reference value REF is between 1 and 2, i.e., 1<REF≤2. At this time, the controller 102 decreases the write weights of various write commands with different write data sizes (e.g., all decreased by 1), or increases the read weights of various read commands with different read data sizes (e.g., all increased by 1). Taking Table 2, for example, in situation 1, the controller 102 may decrease the weight values corresponding to write commands with write data sizes of 4K, 8K, and 16K bytes to 11, 4, and 4, respectively. Taking Table 3, for example, in situation 1, the controller 102 may increase the weight values corresponding to read commands with read data sizes of 4K, 8K, and 16K bytes to 5, 7, and 9, respectively. No matter whether the controller 102 decreases the write weights or increases the read weights, the reference value REF can be decreased to approach 1, and the read performance of the solid-state storage device 10 will be maintained. In addition, referring to FIG. 6 again, each time the controller 102 completes the predetermined number of access commands, regardless of the determination result of step 604, in situation 1, since the reference value REF is between 1 and 2, the read credit control module 114 executed by the controller 102 increases the read credit (e.g., by adding 1).

In situation 2 of FIG. 8A, the reference value REF is between 0 and 1, i.e., 0<REF<1. At this time, the controller 102 increases the write weights of various write commands with different write data sizes (e.g., all increased by 1), or decreases the read weights of various read commands with different read data sizes (e.g., all decreased by 1). No matter whether the controller 102 increases the write weights or decreases the read weights, the reference value REF can be increased to approach 1, and the read performance of the solid-state storage device 10 will be maintained. In Table 2, for example, in situation 2, the controller 102 may increase the weight values corresponding to write commands with write data sizes of 4K, 8K, and 16K bytes to 13, 6, and 6, respectively. In Table 3, for example, in situation 2, the controller 102 may decrease the weight values corresponding to read commands with read data sizes of 4K, 8K, and 16K bytes to 3, 5, and 7, respectively. In addition, referring to FIG. 6 again, each time the controller 102 completes the predetermined number of access commands, regardless of the determination result of step 604, in situation 2, since the reference value REF is between 0 and 1, the read credit control module 114 executed by the controller 102 increases the read credit (e.g., by adding 1).

In situation 3 of FIG. 8A, the reference value REF equals 0 (e.g., REF=0). At this time, the controller 102 increases the write weights of various write commands with different write data sizes (e.g., all increased by 1), or decreases the read weights of various read commands with different read data sizes (e.g., all decreased by 1). Similar to situation 2, no matter whether the controller 102 increases the write weights or decreases the read weights, the reference value REF can be increased to approach 1, and the read performance of the solid-state storage device 10 will be improved. In addition, referring to FIG. 6 again, each time the controller 102 completes the predetermined number of access commands, regardless of the determination result of step 604, in situation 3, since the reference value REF increases and falls between 0 and 1, the read credit control module 114 executed by the controller 102 increases the read credit (e.g., by adding 1).

In situation 4 of FIG. 8A, the reference value REF is greater than 2 (e.g., REF>2). At this time, the controller 102 decreases the write weights of various write commands with different write data sizes (e.g., all decreased by 1), or increases the read weights of various read commands with different read data sizes (e.g., all increased by 1). No matter whether the controller 102 decreases the write weights or increases the read weights, the reference value REF can be decreased to approach 1, and the read performance of the solid-state storage device 10 will be improved. In addition, referring to FIG. 6 again, each time the controller 102 completes the predetermined number of access commands, when the determination result of step 604 is “No,” in situation 4, since the reference value REF is greater than 2, the read credit control module 114 executed by the controller 102 decreases the read credit (e.g., by subtracting 1).

In some embodiments, for purposes of description, assuming that the first ratio N1 is less than the second ratio N2, and the first ratio N1 is a fixed value, the controller 102 may consider four different situations according to the numerical range of the reference value REF, as shown in situations 1 to 4 in FIG. 8B. When the write weight increases or the read weight decreases, the reference value REF decreases (or moves left). When the write weight decreases or the read weight increases, the reference value REF increases (or moves right). In brief, the controller 102 repeatedly attempts to align the first ratio N1 and the second ratio N2, i.e., adjust toward REF=1, thereby allowing the solid-state storage device 10 to allocate read data throughput and write data throughput according to the expected workload ratio.

Please refer to FIG. 8B. In situation 1, the reference value REF is between 1 and 2, i.e., 1<REF≤2. At this time, the controller 102 increases the write weights of various write commands with different write data sizes (e.g., all increased by 1), or decreases the read weights of various read commands with different read data sizes (e.g., all decreased by 1). No matter whether the controller 102 increases the write weights or decreases the read weights, the reference value REF can be decreased to approach 1, and the read performance of the solid-state storage device 10 will be maintained. In addition, referring to FIG. 6 again, each time the controller 102 completes the predetermined number of access commands, regardless of the determination result of step 604, in situation 1, since the reference value REF is between 1 and 2, the read credit control module 114 executed by the controller 102 increases the read credit (e.g., by adding 1).

In situation 2 of FIG. 8B, the reference value REF is between 0 and 1, i.e., 0<REF<1. At this time, the controller 102 decreases the write weights of various write commands with different write data sizes (e.g., all decreased by 1), or increases the read weights of various read commands with different read data sizes (e.g., all increased by 1). No matter whether the controller 102 decreases the write weights or increases the read weights, the reference value REF can be increased to approach 1, and the read performance of the solid-state storage device 10 will be maintained. In addition, referring to FIG. 6 again, each time the controller 102 completes the predetermined number of access commands, regardless of the determination result of step 604, in situation 2, since the reference value REF is between 0 and 1, the read credit control module 114 executed by the controller 102 increases the read credit (e.g., by adding 1).

In situation 3 of FIG. 8B, the reference value equals 0 (e.g., REF=0). At this time, the controller 102 decreases the write weights of various write commands with different write data sizes (e.g., all decreased by 1), or increases the read weights of various read commands with different read data sizes (e.g., all increased by 1). No matter whether the controller 102 decreases the write weights or increases the read weights, the reference value REF can be increased to approach 1, and the read performance of the solid-state storage device 10 will be maintained. In addition, referring to FIG. 6 again, each time the controller 102 completes the predetermined number of access commands, regardless of the determination result of step 604, in situation 3, since the reference value REF increases and falls between 0 and 1, the read credit control module 114 executed by the controller 102 increases the read credit (e.g., by adding 1).

In situation 4 of FIG. 8B, the reference value REF is greater than 2 (e.g., REF>2). At this time, the controller 102 increases the write weights of various write commands with different write data sizes (e.g., all increased by 1), or decreases the read weights of various read commands with different read data sizes (e.g., all decreased by 1). No matter whether the controller 102 increases the write weights or decreases the read weights, the reference value REF can be decreased to approach 1, and the read performance of the solid-state storage device 10 will be improved. In addition, referring again to FIG. 6, each time the controller 102 completes the predetermined number of access commands, when the determination result of step 604 is “No,” in situation 4, since the reference value REF is greater than 2, the read credit control module 114 executed by the controller 102 decreases the read credit (e.g., by subtracting 1).

In one embodiment, the second ratio N2 may be the ratio of the maximum read queue depth (MaxRQD) to the maximum write queue depth (MaxWQD), i.e., N2=MaxRQD/MaxWQD. For purposes of description, the predetermined number (PN) of access commands executed by the controller 102 (e.g., PN=200) includes 20 write commands and 180 read commands, with the maximum write queue depth=1 and the maximum read queue depth=16. At this time, the controller 102 can calculate the first ratio N1=180/20=9 and the second ratio N2=16/1=16. At this time, since the second ratio N2 is greater than the first ratio N1, the controller 102 calculates the reference value REF=N2/N1=16/9=1.7. In addition, the controller 102 can calculate the central read completed count (CRCC) as follows.

$$CRCC = \frac{P N}{N 2 + 1} \times N 2 = \frac{200}{16 + 1} \times 16 = 188$$

In this case, when the reference value REF calculated by the controller 102 is not within the predetermined range (e.g., greater than 2) (i.e., the determination result of step 606 of FIG. 6 is “No”), the controller 102 further determines whether the read completed count is greater than the central read completed count. When the read completed count is greater than the central read completed count, the controller 102 decreases the read credit (e.g., by subtracting 1). When the read completed count is not greater than the central read completed count, the controller 102 increases the read credit (e.g., by adding 1).

According to the embodiments of the present invention, the solid-state storage device can dynamically adjust the resources of write commands and read commands to meet the requirements of varying system workloads. For example, appropriate write/read data bandwidth can be provided based on the write data size, write queue depth, read data size, and read queue depth, thereby solving QoS latency problems. In addition, the embodiments of the present invention can maintain the processing performance of the solid-state storage device under different system workloads and effectively meet the requirements of QoS.

Although the present invention is disclosed herein with preferred embodiments, it is not intended to limit the scope of the present invention. Persons of ordinary skill in the art can make some modifications without departing from the spirit and scope of the present invention. Therefore, the scope of the present invention shall be determined by the appended claims.

What is claimed is:

1. A solid-state storage device, configured to be electrically connected to a host, the solid-state storage device comprising:
a controller;
a non-volatile memory, electrically connected to the controller, and configured to store write data provided by the host; and
a volatile memory, wherein the volatile memory comprises a submission queue and a wait queue;
wherein the controller is configured to fetch a plurality of access commands from the host, and record the access commands in the submission queue, the access commands comprising a plurality of write commands and a plurality of read commands,
wherein in response to the controller fetching a first write command of the write commands from the submission queue, the controller is configured to determine whether a read count value of the read commands and a standby time from receiving the first write command meet a target condition,
wherein in response to the read count value and the standby time meeting the target condition, the controller is configured to execute the first write command,
wherein in response to the read count value and the standby time not meeting the target condition, the controller is configured to retain the first write command in the wait queue.

2. The solid-state storage device of claim 1, wherein:
in response to the controller fetching the first write command from the submission queue, the controller is configured to determine whether the read count value of the read commands equals a read credit, the read credit being a ratio of a number of read commands to a number of write commands executed by the controller;
in response to the read count value equaling the read credit, the controller is configured to execute the first write command;
in response to the read count value not equaling the read credit, the controller is configured to determine whether the standby time from receiving of the first write command exceeds a predetermined time;
in response to the standby time exceeding the predetermined time, the controller is configured to process the first write command; and
in response to the standby time not exceeding the predetermined time, the controller is configured to retain the first write command in the wait queue.

3. The solid-state storage device of claim 2, wherein in response to the controller successfully programming the write data of the first write command into the non-volatile memory, the controller is configured to reset the read count value and the standby time.

4. The solid-state storage device of claim 2, wherein:
each time the controller completes a predetermined number of the access commands, the controller is configured to determine whether a read queue depth of the read commands is greater than a write queue depth of the write commands, and whether a read completed count value of the read commands is less than a write completed count value of the write commands; and
in response to the read queue depth being greater than the write queue depth and the read completed count value being less than the write completed count value, the controller is configured to increase the read credit by 1.

5. The solid-state storage device of claim 4, wherein:
in response to the read queue depth not being greater than the write queue depth or the read completed count value not being less than the write completed count value, the controller is configured to determine whether a reference value is within a predetermined range;
in response to the reference value being within the predetermined range, the controller is configured to increase the read credit by 1; and
in response to the reference value not being within the predetermined range, the controller is configured to decrease the read credit by 1.

6. The solid-state storage device of claim 5, wherein:
the controller is configured to divide the read completed count value by the write completed count value to obtain a first ratio, and divide a read command weighted score of the read commands by a write command weighted score of the write commands to obtain a second ratio;
in response to the first ratio being greater than the second ratio, the controller is configured to divide the first ratio by the second ratio to obtain the reference value; and
in response to the first ratio not being greater than the second ratio, the controller is configured to divide the second ratio by the first ratio to obtain the reference value.

7. The solid-state storage device of claim 6, wherein:
the controller is configured to assign an individual read weight to each read command according to read data sizes of the read commands, and assign an individual write weight to each write command according to write data sizes of the write commands; and
the controller is configured to sum the individual read weights of the read commands to obtain the read command weighted score, and sum the individual write weights of the write commands to obtain the write command weighted score.

8. The solid-state storage device of claim 6, wherein the controller is configured to adjust the individual read weights of the read commands or the individual write weights of the write commands to cause the reference value to approach a target value within the predetermined range.

9. The solid-state storage device of claim 8, wherein:
in response to the reference value being within the predetermined range, the controller is configured to increase the read credit; and
in response to the reference value not being within the predetermined range, the controller is configured to decrease the read credit.

10. A dynamic quality-of-service (QoS) management method for a solid-state storage device, the solid-state storage device being electrically connected to a host, and the solid-state storage device comprising a controller, a volatile memory, and a non-volatile memory, the method comprising:
utilizing the controller to fetch a plurality of access commands from the host, and recording the access commands in a submission queue of the volatile memory, wherein the access commands comprise a plurality of write commands and a plurality of read commands;
in response to the controller fetching a first write command of the write commands from the submission queue, utilizing the controller to determine whether a read count value of the read commands and a standby time from receiving the first write command meet a target condition;
in response to the read count value and the standby time meeting the target condition, utilizing the controller to execute the first write command; and
in response to the read count value and the standby time failing to meet the target condition, utilizing the controller to retain the first write command in a wait queue of the volatile memory.

11. The method of claim 10, further comprising:
in response to the controller fetching the first write command from the submission queue, utilizing the controller to determine whether the read count value of the read commands equals a read credit, wherein the read credit is a ratio of a number of read commands to a number of write commands executed by the controller;
in response to the read count value equaling the read credit, utilizing the controller to execute the first write command;
in response to the read count value not equaling the read credit, utilizing the controller to determine whether the standby time from receiving the first write command exceeds a predetermined time;
in response to the standby time exceeding the predetermined time, utilizing the controller to process the first write command; and
in response to the standby time not exceeding the predetermined time, utilizing the controller to retain the first write command in the wait queue.

12. The method of claim 11, further comprising, in response to the controller successfully programming write data of the first write command into the non-volatile memory, utilizing the controller to reset the read count value and the standby time.

13. The method of claim 11, further comprising:
each time the controller completes a predetermined number of the access commands, utilizing the controller to determine whether a read queue depth of the read commands is greater than a write queue depth of the write commands, and whether a read completed count value of the read commands is less than a write completed count value of the write commands; and
in response to the read queue depth being greater than the write queue depth and the read completed count value being less than the write completed count value, utilizing the controller to increase the read credit by 1.

14. The method of claim 13, further comprising:
in response to the read queue depth not being greater than the write queue depth or the read completed count value not being less than the write completed count value, utilizing the controller to determine whether a reference value is within a predetermined range;
in response to the reference value being within the predetermined range, utilizing the controller to increase the read credit by 1; and
in response to the reference value not being within the predetermined range, utilizing the controller to decrease the read credit by 1.

15. The method of claim 14, further comprising:
utilizing the controller to divide the read completed count value by the write completed count value to obtain a first ratio, and to divide a read command weighted score of the read commands by a write command weighted score of the write commands to obtain a second ratio;
in response to the first ratio being greater than the second ratio, utilizing the controller to divide the first ratio by the second ratio to obtain the reference value; and
in response to the first ratio not being greater than the second ratio, utilizing the controller to divide the second ratio by the first ratio to obtain the reference value.

16. The method of claim 15, further comprising:
utilizing the controller to assign an individual read weight to each read command according to read data sizes of the read commands, and to assign an individual write weight to each write command according to write data sizes of the write commands; and
utilizing the controller to sum the individual read weights of the read commands to obtain the read command weighted score, and to sum the individual write weights of the write commands to obtain the write command weighted score.

17. The method of claim 16, further comprising:
utilizing the controller to adjust the individual read weights of the read commands or the individual write weights of the write commands to cause the reference value to approach a target value within the predetermined range.

18. The method of claim 17, further comprising:
in response to the reference value being within the predetermined range, utilizing the controller to increase the read credit; and
in response to the reference value not being within the predetermined range, utilizing the controller to decrease the read credit.
